(19) United States
(12) Patent Application Publication
(10) Pub. No.: US 2006/0131374 A1
(43) Pub. Date: Jun. 22, 2006

(54) Calculator with wrist rest

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/020,783

(22) Filed: Dec. 22, 2004

(51) Int. Cl. G06G 1/00

(52) U.S. Cl. 235/61 R

(57) ABSTRACT

A calculator with a retractable and extendable padded area to support the user's wrist. The padded area is mounted atop a sliding surface such that the padded area and sliding surface may be extended from a hollow compartment space in the calculator housing located below the operative electronics. When use of the pad is not desired, it retracts into the calculator housing and is secured in the housing by a hinged door. While the pad may be constructed of a number of materials, a gel substance encapsulated within the pad would perform well. The outer surfaces of the calculator and extendable surface, having relatively smooth surfaces, are also well-suited for application of art work, logos and graphics for advertising and promotional purposes.

### BACKGROUND OF THE INVENTION

Portable calculators have long been well known to those skilled in the art as well as to the general public. As workplace requirements demand increasing repetitive hand and digit movements, such as the operation of a computer keyboard or of a small calculator, the incidence of wrist fatigue and injury, such as carpal tunnel syndrome are likewise increasing.

Computer peripheral suppliers attempted to meet this need through the manufacture of wrist pads which are placed in front of a keyboard so as to support the wrists when using the keyboard. Such devices are described, for example, in U.S. Pat. No. 5,356,009 to Sereboff, U.S. Pat. No. 5,476,491 to Mayn and U.S. Pat. No. 5,980,143 to Bayer, et al. These devices are quite large and bulky, however, and typically remain in place at all times, thereby requiring additional surface work space.

Wrist pads have been introduced for personal calculators as well, such as those described in U.S. Pat. No. D452,248 to Li. These pads, however, are typically integrally molded or formed with the calculator body. The inherent disadvantage of these designs is that they render the calculator large and bulky as the wrist pad is configured as a permanent extension at the front base of the calculator. The pad must remain in place at all times, regardless of whether the user requires or desires to utilize the pad. In addition, these wrist pad calculators are a “one size fits all” product, and the user has no means for adjusting the location of the padded surface to suit his or her wrist and hand size. The larger size of the conventional padded calculators also inhibits their portability, as the calculator will no longer fit in one's pocket and requires extra space in a briefcase or other tote.

What is lacking in conventional wrist support designs adapted to personal calculators is a means by which the relative location of the pad may be adjusted by each user to suit his or her physical size and proportions from wrist to fingertip, as well as their hand posture when using a calculator keyboard.

In addition, the conventional padded calculator designs lack the capability to alternatively use or store away the padded surface, depending upon the desire of the user. Having a means to store the pad would reduce the size of the calculator “footprint” as well as restore the portability which was the hallmark of conception of the personal hand held calculator.

### SUMMARY OF THE INVENTION

The present invention meets the need for a personal hand held calculator with an integral wrist support padded surface. Through the incorporation of a generally rectangular cavity in the housing, the invention permits the padded surface to be stored within the housing envelope and thereafter extended from the housing for use with the calculator. As the padded surface is freely extended, the user may extend or retract the pad to the location of maximum support and comfort of his or her wrist. When the user does not desire or require the use of a wrist pad, the padded surface can simply be retracted into the housing. A hinged door or other closing mechanism may then be used to close the hidden storage compartment and secure the calculator for portability.

With the padded surface retracted, the present invention requires no more desktop surface area than would a conventional calculator device having similar functional capabilities. The calculator will more easily fit into briefcases, totes or other storage and transportation means.

The present invention is a generally rectangular calculator which includes a hollow cavity defined by the inner surfaces of the housing below the keyboard and electronics. Within the generally rectangular cavity resides a typically flat and thin surface which is of appropriate length to be retracted into and possibly stored within the dimensions of the inner portion of this housing cavity. The surface would usually have a padded area on its outwardly extending end which constitutes the wrist support. Based upon the size of the calculator and the needs of the individual user, the flat surface and pad may retract completely into the housing cavity or may require additional length such that some portion of the pad would remain outside the housing at all times.

Should the present invention be configured to permit the flat plate and padded area to reside completely within the housing cavity, a door or other type of closure mechanism may be utilized to securely close and confine the housing cavity.

In other embodiments of the present invention, the padded area could be replaced by a notepad, clock, timer or any number of devices which may fit within the confines of the housing compartment and be beneficial to the user of a hand held calculator.

### BRIEF DESCRIPTION OF THE DRAWINGS

FIG. 1 is a top perspective view of a preferred embodiment of the Calculator, which shows the hinged door of the storage compartment in the closed position and the display is in its lowered position.

FIG. 2 is a top perspective view of a preferred embodiment of the Calculator, which shows the hinged door of the storage compartment in the closed position and the display is in its raised position.

FIG. 3 is a top perspective view of a preferred embodiment of the Calculator, which shows the hinged door of the storage compartment in the open position with the wrist rest surface extended out from the housing compartment and the display is in its lowered position.

FIG. 4 is a cross sectional view of a preferred embodiment of the Calculator, which shows the wrist rest surface retracted into the housing compartment and the hinged door in its closed position.

FIG. 5 is a cross sectional view of a preferred embodiment of the Calculator, which shows the wrist rest surface partially extended from the housing compartment with the hinged door in its almost fully open position.

FIG. 6 is a cross sectional view of a preferred embodiment of the Calculator, which shows the wrist rest surface fully extended from the housing compartment with the hinged door in its fully open position.

### DETAILED DESCRIPTION OF THE PREFERRED EMBODIMENT

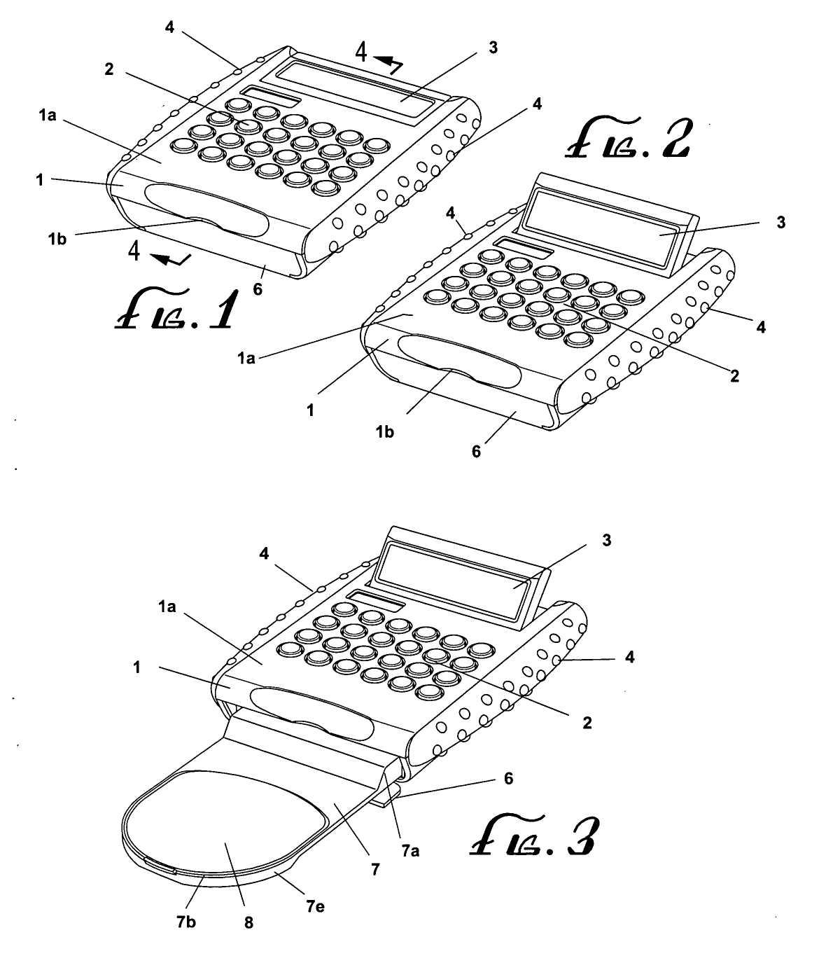

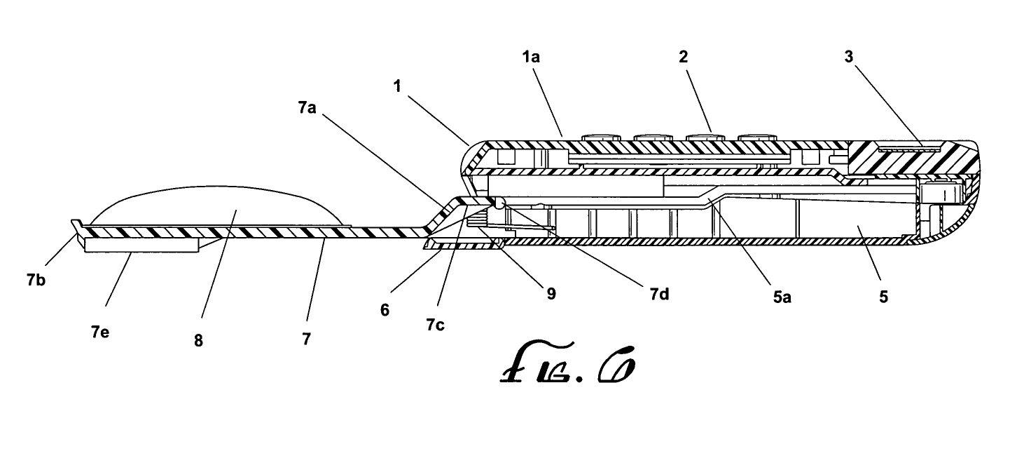

Referring to FIGS. 1 and 2, the preferred embodiment includes that of a calculator with many components which are well known to those skilled in the art. The calculator includes a generally rectangular housing 1, having operating electronics enclosed within the housing and operative components including an array of actuating buttons 2, and a display panel 3 located on a front surface 1a of the housing 1. In the preferred embodiment, the display 3 may remain in the flat position as shown in FIG. 1 or it may be tilted for improved viewing, as shown in FIG. 2. The preferred embodiment further may include resilient gripping structures 4, mounted to extend along opposite sides of the housing 1. The hollow compartment 5 of the preferred embodiment is within the housing 1 and occupies the space below the operative electronics. A hinged door 6, shown in its closed position in FIG. 1 and in its partially open and fully open positions in FIGS. 5 and 6, respectively, defines the perimeter of and closes the hollow compartment 5 when the door 6 is closed.

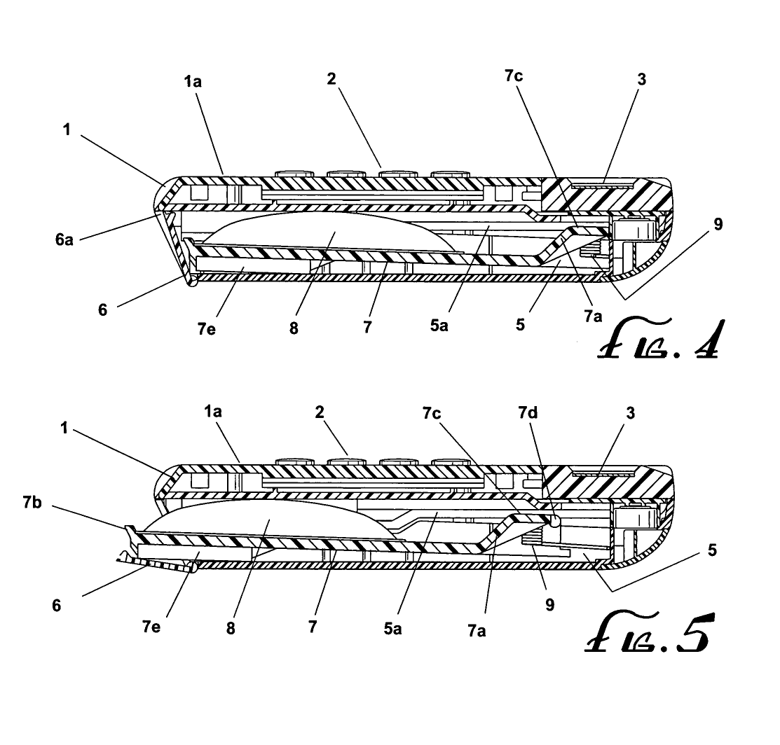

Referring to FIG. 3, the preferred embodiment includes a sliding surface 7 on which a wrist support pad 8 resides. As described in greater detail below, in practice the user would open the hinged door 6 and a spring 9 mechanism serves to eject the sliding surface 7 and pad 8 a short distance out of the hollow compartment 5 so the user may grasp the surface 7 and pad 8 and extend them an appropriate length to suit their individual wrist resting position for comfort.

FIG. 4 depicts the hollow compartment 5 in its fully closed position with the sliding surface 7 and wrist support pad 8 fully enclosed and stored therein. The sliding surface 7 is angled downward beginning at its inboard end 7a such that the rear portion 7b of the surface 7 on which the pad 8 is mounted will be lower than the points of attachment 7c of the surface 7 to the hollow compartment 5. In a preferred embodiment, the sliding surface 7 may further include outward extending pins 7d, which extend perpendicular to the axis of extension. These pins 7d ride in a pair of tracks 5a on opposite inner sides of the hollow compartment 5, and serve to maintain the alignment of the sliding surface 7 with respect to the inner sides of the hollow compartment, for smooth extension and retraction of the sliding surface 7 and pad 8.

The hinged door 6 in the preferred embodiment is a simple device as its hinges incorporate internal friction to maintain tightness in the hinged body and the door includes a closure tab 6a which fits into a mating recess 1b in the housing 1. An helical spring 9 biases the inboard end of the sliding surface against the innermost end of the hollow compartment 5. By finger pressure on the door 6, the tab 6a may be withdrawn from the recess 1b, thus permitting the door 6 to open. Once open, the outward axial force exerted by the spring 9 causes the sliding surface to extend outward from the housing 1 and compartment 5. In the preferred embodiment, the spring 9 is selected based on its capability to only partially extend the sliding surface 7 from the hollow compartment 5. If the spring force were too low, the surface 7 would not extend from the compartment 5, however, too stiff a spring 9 would cause the surface to fully extend and might therefore interfere with the user's ability to position the wrist support pad 8 at the appropriate extended length for personal comfort. The sliding surface 7 may further include a stage lip 7e on the underside of its outboard end. This lip 7e would serve to render the sliding surface generally parallel to the surface on which the calculator rests as well as to slightly raise the base height of the pad 8 so as to maintain the appropriate height of the user's wrist with respect to the array of actuating buttons 2 for optimum comfort. The pad 8 is typically attached to the sliding surface 7 by means of adhesive or other well known attachment means. In the preferred embodiment, the wrist support pad 7 is a generally smooth surfaced pad which encapsulates a gel material for increased comfort and conformance to the user's wrist shape.

To retract the sliding surface 7 and pad 8, the user manually pushes the surface 7 and pad 8 back into the hollow compartment 5 and raises the door 6 to the point where the closure tab 6a is inserted into the mating recess 1b of the housing 1.

The outer surfaces of the housing 1, sliding surface 7 and pad 8, having relatively smooth surfaces, are also well-suited for application of art work, logos and graphics for advertising and promotional purposes.

What is claimed is:

1. A calculator comprising:
a generally flat surfaced housing having operating electronics enclosed within the housing and operative components comprising an array of actuating buttons and a display panel located on a front surface of said housing proximate said array of actuator buttons,
a hollow compartment within the housing located below the operative components, and a wrist rest surface slidably extendable from and retractable into said compartment.

2. The calculator of claim 1 further comprising a door to enclose the compartment space.

3. The calculator of claim 1 wherein the wrist rest surface further comprises a padded area for wrist support.

4. The calculator of claim 2 wherein the door is connected to the housing by spring biased hinges.

5. The calculator of claim 3 wherein the padded area includes a gel material inside a pad secured to the wrist rest surface.

6. The calculator of claim 1 further including printed or graphical imprinting on at least one surface for the purposes of advertising or promotion of goods or services.

7. The calculator of claim 1 wherein resilient gripping structures are mounted to extend along opposite sides of said housing.

8. A calculator comprising:
a generally flat surfaced housing having operating electronics enclosed within the housing and operative components comprising an array of actuating buttons and a display panel located on a front surface of said housing proximate said array of actuator buttons,
a hollow compartment within the housing, located below the operative components and enclosed by means of a door, and further including a slidably extendable and retractable padded wrist surface capable of being stored within said space and, alternatively extending outward from the housing envelope.

9. The calculator of claim 8 wherein the padded area includes a gel material inside a pad secured to the extendable and retractable surface.

10. The calculator of claim 8 further including printed or graphical imprinting on at least one surface for the purposes of advertising or promotion of goods or services.

11. The calculator of claim 8 wherein resilient gripping structures are mounted to extend along opposite sides of said housing.

12. A method of advertising or promotion comprising the imprinting of printed or graphical material on a surface of a calculator which has:
a generally flat surfaced housing having operating electronics enclosed within the housing and operative components comprising an array of actuating buttons and a display panel located on a front surface of said housing proximate said array of actuator buttons; and,
a hollow compartment within the housing, located below the operative components which further includes a slidably extendable and retractable wrist rest surface capable of being stored within said space and, alternatively extending outward from the housing envelope.
